(19) United States
(12) Patent Application Publication
(10) Pub. No.: US 2023/0349482 A1
(43) Pub. Date: Nov. 2, 2023

(54) THERMOSTATIC ASSEMBLY, IN PARTICULAR A THERMOSTATIC CARTRIDGE

(71) Applicant: VERNET, Ollainville (FR)

(72) Inventors: Laurie Cécile Marie LOUBOUTIN, Arpajon (FR); Matthieu DRABER, Milly-La-Foret (FR)

(21) Appl. No.: 17/997,186

(22) PCT Filed: Apr. 28, 2021
(86) PCT No.: PCT/EP2021/061133

§ 371 Date: Oct. 26, 2022

(30) Foreign Application Priority Data
Apr. 29, 2020 (FR) FR2004251

(51) Int. Cl. F16K 31/00; G05D 23/13

(52) U.S. Cl. CPC F16K 31/002; G05D 23/134

(57) ABSTRACT

A thermostatic assembly comprises a casing in which are delimited a chamber where hot and cold fluids mix to form a mixed fluid, a hot fluid inlet, a cold fluid inlet and a mixed fluid outlet. This assembly also comprises a thermostatic element including a thermosensitive body and a piston which move relative to one another along a central axis (X-X) of the chamber as a function of the temperature of the mixed fluid. A spool regulates the temperature of the mixed fluid, being connected to the thermosensitive body to be moved along the central axis in the chamber so as to close, in respective inverse proportions, hot and cold fluid passages which are each delimited, along the central axis, between the spool and the casing. In order to make this assembly more adaptable to various geometries of the installation environment, the spool has a profile that is non-circular.

This is the National Stage of PCT international application PCT/EP2021/061133, filed on Apr. 28, 2021, which claims the priority of French Patent Application No. 2004251, filed Apr. 29, 2020, both of which are incorporated herein by reference in their entirety.

The present invention relates to a thermostatic assembly, in particular a thermostatic cartridge.

To regulate the temperature of a mixture of a hot fluid and a cold fluid, in particular a mixture of hot and cold water in a sanitary installation, it is known how to use a thermostatic element and a spool, which are arranged in a hollow outer casing, typically a cartridge body to be added into a tap body. The thermostatic element comprises a piston, which is normally fixed with respect to the casing, and a thermosensitive body, with respect to which the piston can be moved in translation along a central axis under the effect of a thermal expansion of the thermostatic element, the spool being rigidly attached to the thermosensitive body. The spool is mounted so as to be apt to be movable in translation inside a chamber of the casing so as to close, in opposite respective proportions, a first passage, which is axially delimited between the spool and the casing and which is supplied with hot fluid through a hot fluid inlet delimited by the casing, and a second passage, which is axially delimited between the spool and the casing and which is supplied with cold fluid through a cold fluid, inlet delimited by the casing. The hot fluid and the cold fluid the spool lets through the two passages so as to reach the chamber, mix therein and downstream of the spool, form a mixed fluid which leaves the casing by flowing along the thermosensitive body of the thermostatic element. The thermostatic regulation temperature i.e. the equilibrium temperature around which the temperature of the mixed fluid is regulated, can be set by changing the position of the piston with respect to the casing, usually by means of an ad hoc control mechanism,

An example of such type of cartridge is provided by FR 2 921 709.

The movement of the spool inside the chamber, which is controlled by the thermostatic element, has to be as accurate as possible so that the temperature of the mixed fluid around a setpoint value, is reached reliably and efficiently. In practice, the spool is guided in movement by a lateral wall of the chamber, with the radial interposition, between the lateral wall of the chamber and the lateral edge of the spool, of a peripheral seal that is located between the hot fluid and the cold fluid inlets delimited by the casing. In such context, the spool is typically provided with a circular profile, so that the lateral edge of the spool has a cylindrical shape with a circular base, around which the seal runs and which is girdled in a supplementary manner by the lateral wall of the chamber. The manufacture and the assembly of the spool, the seal and the chamber are substantially facilitated, while being particularly economical. Given the above, the circular geometry at the spool establishes perpendicular to the central axis, a given diametrical dimension related to a minimum value for the mixed fluid flow rate, the minimum value being e.g. established by standards or sought for the end user. However, the given diametrical dimensioning can be challenging when the environment wherein the thermostatic assembly is to be implanted, is constrained from a dimensional point of view, e.g. when the surroundings have a smaller dimension than said other two dimensions.

Another example is provided by EP 0 707 720, the particularity of which is that the hot fluid inlet, the cold fluid inlet and the mixed fluid outlet are integrated into a central body of the casing, the central body being circular and being arranged inside the spool which also has a circular profile.

The goal of the present invention is to propose a new thermostatic assembly, in particular a new thermostatic cartridge, which, while providing efficient thermostatic regulation, is more adaptable to various geometries of the surroundings.

To this end, the subject matter of the invention is a thermostatic assembly, comprising:
a casing in which are delimited:
   a chamber which defines a central axis and in which a hot fluid and a cold fluid mix for forming a mixed fluid,
   a hot fluid inlet through which the hot fluid enters the chamber from outside the casing,
   a cold fluid inlet through which the cold fluid enters the chamber from outside the casing, and
   a mixed fluid outlet through which the mixed fluid contained in the chamber exits the casing,
a thermostatic element which includes a thermosensitive body, arranged for being in contact with the mixed fluid, and a piston connected to the casing, the thermosensitive body and the piston moving relative to each other along the central axis depending on the temperature of the mixed fluid, and
a spool for regulating the temperature of the mixed fluid, the spool being connected to the thermosensitive body of the thermostatic element so as to be moved along the central axis inside the chamber so as to close off, in opposite respective proportions, a hot fluid passage and a cold fluid passage which are each delimited, along the central axis, between the spool and the casing, the hot fluid passage being fed by the hot fluid coming from the hot fluid inlet while the cold fluid passage is fed with the cold fluid coming from the cold fluid inlet.

According to the invention, the spool has, in a section transverse to the central axis, a profile which is non-circular.

One of the ideas behind the invention is to step away from the traditional circular designs for the spool. Such traditional circular designs are associated with the technical bias that the manufacture of the spool and the mounting thereof in guided translation inside the casing, is simpler and more efficient. The invention goes against such prejudice by making the profile (in other words the outer contour) non-circular, the spool presenting said profile in a section transverse to the axis along which the spool is moved in translation so as to thermostatically regulate the mixture between the hot and cold fluid. It should be clearly understood that the invention does not relate to dimensional tolerances that known spools with a circular profile can have along the outer periphery thereof, but that the invention provides, for the profile of the spool, a predetermined geometry which is intentionally non-circular, where the non-circular geometry can be either symmetrical or asymmetrical. In other words, the spool according to the invention can be described as a shaped spool. Thus, the profile of the spool can e.g. be oval or can include one or a plurality of rectilinear edges, corresponding examples being given in detail and specified thereafter. In all cases, the non-circular geometry for the spool profile allows the thermostatic assembly according to the invention to save space, by being apt to adapt to surroundings having a constrained geometry compared to surroundings having dimensions that are sufficient for receiving a thermostatic assembly the spool of which would be circular. Thus, e.g. when the surroundings have a smaller dimension than said other two dimensions, the spool of the thermostatic assembly according to the invention can advantageously be provided with a profile which is longer than is wider, such as an oblong or elliptical profile, and the width of which extends along the direction of the smallest dimension of the surroundings. In all cases, the performance of the thermostatic assembly according to the invention is similar to the performance of a known thermostatic assembly with a circular spool as long as the perimeter of the spool with a non-circular profile provided by the invention is identical to the perimeter of the circular spool, thus making it possible, between the thermostatic assembly according to the invention and the known thermostatic assembly, to have a similar fluid flow cross-section and hence to let through a similar mixed fluid flow rate.

According to advantageous additional features of the thermostatic assembly according to the invention:
the profile of the spool has a first dimension, as measured along a first geometric axis perpendicular to the central axis, which is greater than a second dimension of the profile of the spool, as measured along a second geometric axis perpendicular to both the central axis and the first geometric axis;
the profile of the spool is oval, in particular elliptical;
the profile of the spool includes two parallel rectilinear edges, the profile being in particular oblong or rectangular with rounded corners;
the casing has a total dimension measured along the second geometric axis, which is smaller than all the other total dimensions of the casing;
the hot fluid inlet, the cold fluid inlet and the mixed fluid outlet extend from the chamber in the same geometric plane containing the central axis and the first geometric axis;
the casing includes a first housing and a second housing, which are distinct from each other, the hot fluid passage being delimited between the spool and the first housing while the cold fluid passage is delimited between the spool and the second housing, and the first housing and the second housing are rigidly joined to each other by means of an added part;
the added part is a fork which is arranged transversely to the central axis;
the thermostatic assembly further includes a mechanism for controlling the temperature of the mixed fluid, the mechanism being borne by the second housing and connecting the piston of the thermostatic element to the casing so as to adjust the position of the piston along the central axis;
the thermostatic assembly forms a thermostatic cartridge suitable for being added in a single piece into a tap body.

The invention will be better understood upon reading the following description, given only as an example and making reference to the drawings, wherein:

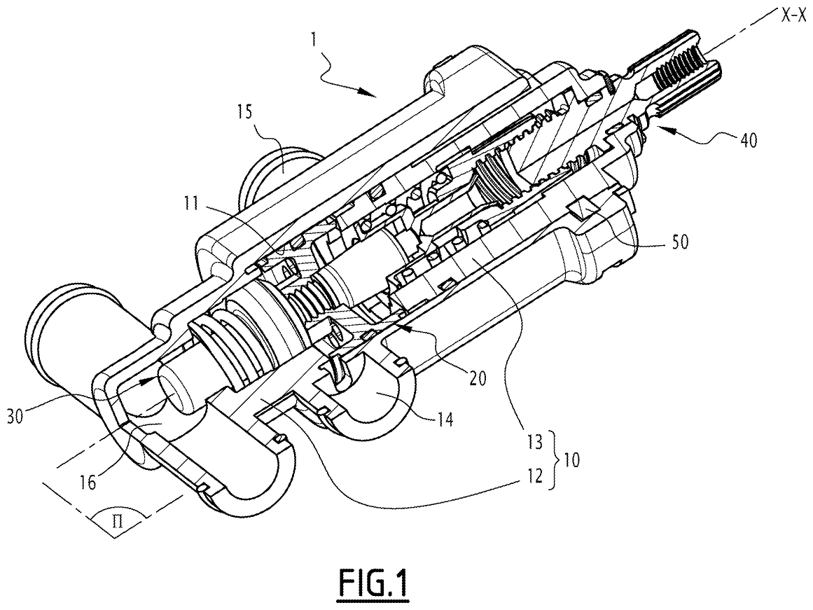

FIG. 1 is a perspective view, with partial section, of a first embodiment of a thermostatic assembly according to the invention, produced in the form of a thermostatic cartridge;

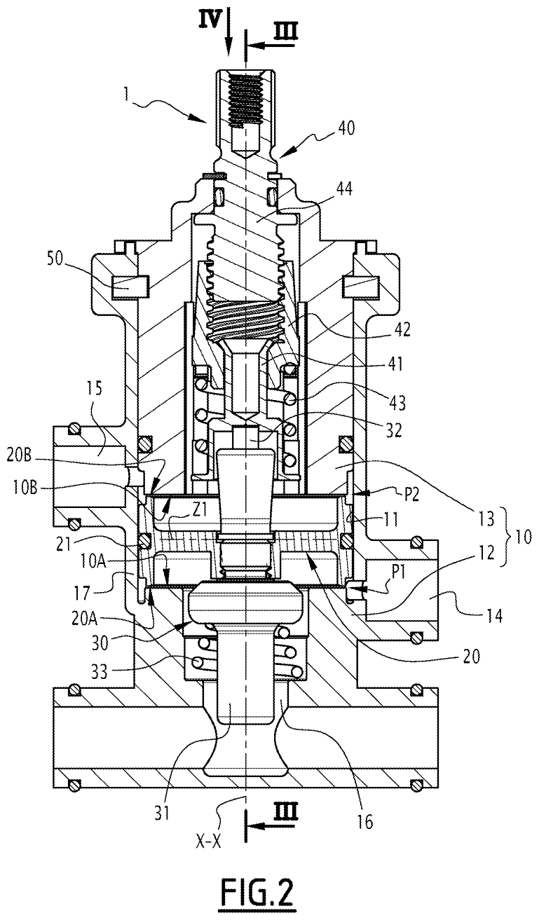

FIG. 2 is a longitudinal section of the cartridge shown in FIG. 1;

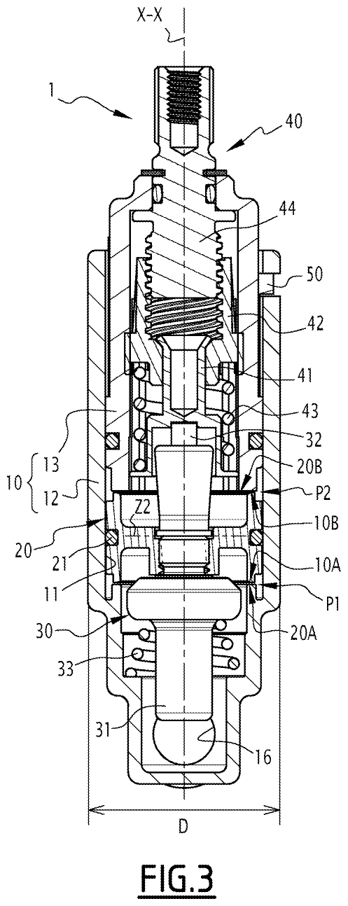

FIG. 3 is a section along the line III-Ill shown in FIG. 2;

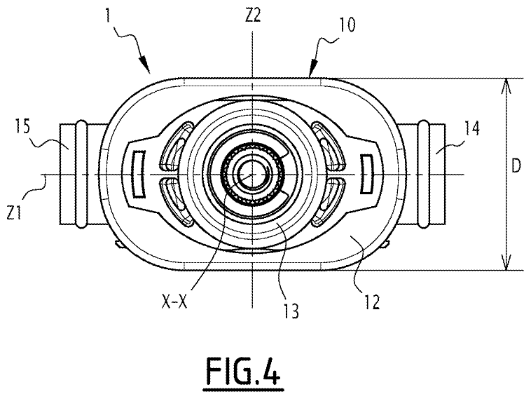

FIG. 4 is an plan view of the cartridge shown in FIG. 1, according to the arrow IV shown in FIG. 2;

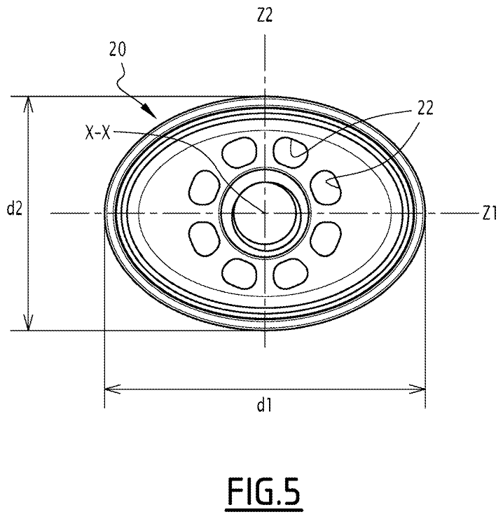

FIG. 5 is a plan view of a spool of the cartridge shown in FIG. 1, along the same direction of observation as FIG. 4;

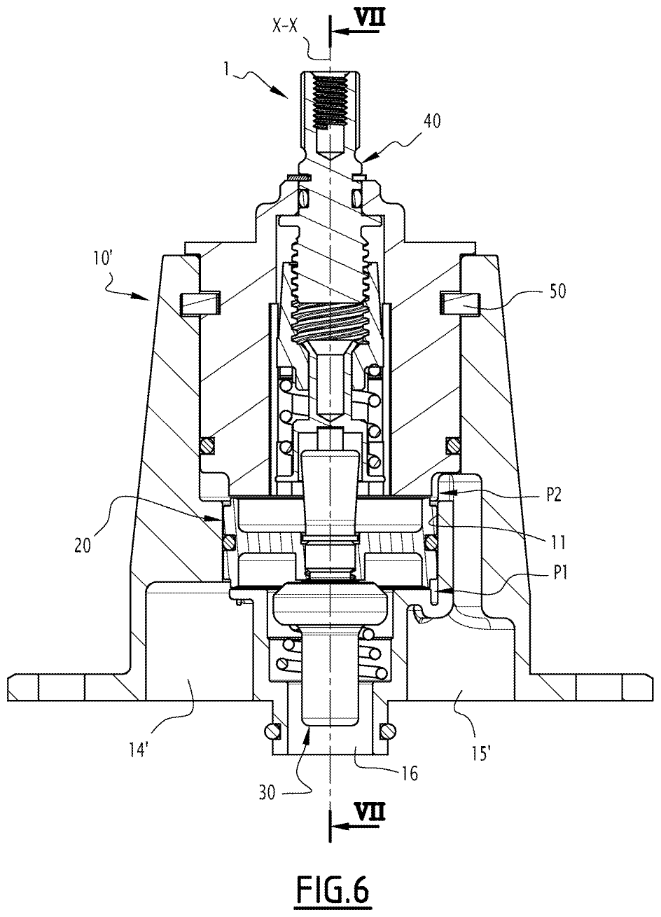

FIG. 6 is a view similar to FIG. 2, illustrating a second embodiment of a thermostatic assembly according to the invention, which is produced in the form of a thermostatic cartridge; and

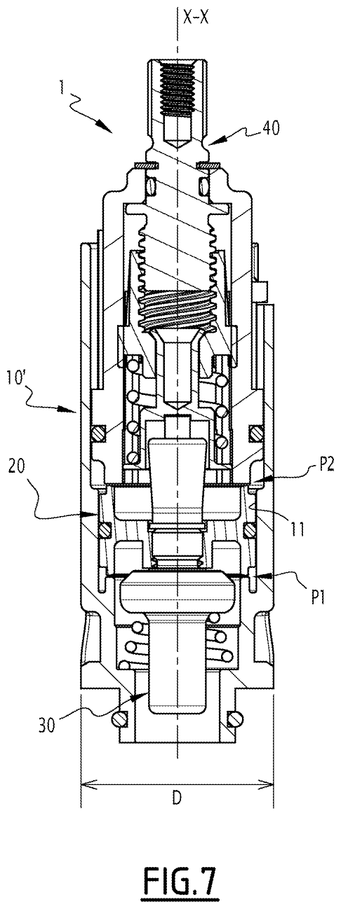

FIG. 7 is a section along the line VII-VII shown in FIG. 6.

FIGS. 1 to 4 show a thermostatic cartridge 1 arranged around and along a central axis X-X. The thermostatic cartridge 1 is suitable for equipping a mixer tap to be supplied with hot water and cold water, not shown as such in the figures, or, more generally, for equipping an installation supplied with a hot fluid and a cold fluid to be mixed.

The thermostatic cartridge 1 includes, as the main external component, a hollow casing 10. The casing 10 is intended for being mounted leak-tight in a body of the aforementioned mixing valve.

The casing 10 internally delimits a chamber 11 that is cylindrical and centered on the axis X-X. The hot and the cold water to be regulated by the thermostatic cartridge 1 are designed to mix inside the chamber 11, producing mixed water therein.

For convenience, the remainder of the description is oriented with respect to the axis X-X, in the sense that the terms “upper” and “top” correspond to an axial orientation oriented toward the upper part of FIGS. 2 and 3, while the terms “lower” and “bottom” correspond to an axial direction along the opposite direction.

In the example of embodiment considered in the figures, and as can be clearly seen in FIGS. 1 to 3, the casing 10 includes two distinct housings, namely a lower housing 12 and an upper housing 13, which are rigidly attached to one another. The chamber 11 is delimited jointly by the lower housing 12 and the upper housing 13, being formed by an internal volume of the lower housing 12 inside which the upper housing 13 is arranged leak-tight without the latter occupying the whole aforementioned internal volume. The embodiment of the casing 10, herein associating the lower housing 12 and the upper housing 13, is not limiting, and it should be noted that advantageous features of such embodiment of the casing 10 will be detailed hereafter, in connection with certain technical aspects of the rest of the thermostatic cartridge 1.

Whatever the embodiment thereof, the casing 10 has a hot water inlet 14, a cold water inlet 15 and a mixed water outlet 16, each of which connects—in a manner distinct from one another—the outside of the casing 10 to the chamber 11. The opening of the hot water inlet 14 into the chamber 11 and the opening of the cold water inlet 15 into the chamber 11 are offset axially from one another, being separated from one another by a lateral wall 17 of the chamber 11, centered on the axis X-X. The embodiment of the hot water inlet 14, the cold water inlet 15 and the mixed water outlet 16 is not limiting as long as the hot water inlet 14 forms an entrance through which the hot water enters the chamber 11 from outside the casing 10, that the cold water inlet 15 forms an entrance through which the cold water enters the chamber 11 from outside the casing 10, and that the mixed water outlet 16 forms an exit through which the mixed water contained in the chamber 11 leaves the casing 10.

In the example of embodiment considered in the figures, and as more particularly visible in FIGS. 1, 2 and 4, the hot water inlet 14 and the cold water inlet 15 extend from the chamber 11 radially to the axis X-X, occupying respective portions of the casing 10, about the axis X-X, which are diametrically opposed to each other. As for the mixed water outlet 16, same extends from the chamber 11 parallel to the central axis X-X, being even substantially centered on the central axis, before being extended by two opposite elbows which each extend radially to the central axis X-X, being diametrically opposed to each other. Furthermore, the lower housing 12 delimits both the hot water inlet 14, the cold water inlet 15 and the mixed water outlet 16 and includes the side wall 17 of the chamber 11.

The thermostatic cartridge 1 further includes a spool 20, which can be seen in FIGS. 1 to 3 and which is shown alone in FIG. 5. The spool 20 is mounted inside the chamber 11 so as to be apt to move along the central axis X-X between two extreme positions, namely:
an extreme bottom position, wherein a seat 20A of the spool 20, which is located at a lower axial end of the spool, bears axially against a seat 10A of the casing 10, which is located along the central axis X-X, substantially at the outlet of the hot water inlet 14 inside the chamber 11, and
an extreme top position, wherein a seat 20B of the spool 20, which is located at an upper axial end of the spool 20, bears against a seat 10B of the casing 10, which is located, along the central axis X-X, substantially at the outlet of the cold water inlet 15 inside the chamber 11.

In the example of embodiment considered in the figures, the seat 10A of the casing 10 is formed by the lower housing 12, more precisely by a shoulder of the latter, while the seat 10B of the casing is formed by the upper housing 13, more precisely by a lower end edge of the latter. As for the seats 20A and 20B of the spool 20, same are formed by lower and upper end edges respectively, of the spool 20.

In all cases, the axial dimension of the spool 20 separating the opposite seats 20A and 20B thereof from each other, is less than the axial distance separating the seats 10A and 10B of the casing 10 from each other. Thus, the seat 20A of the spool 20 and the seat 10A of the casing 10 delimit between them, along the axis X-X, a hot water passage P1 through which the hot water inlet 14 opens into the chamber 11. Similarly, the seat 20B of the spool 20 and the seat 10B of the casing 10 between them define, along the axis X-X, a cold water passage P2 through which the cold water inlet 15 opens into the chamber 11.

It will be understood that, when the spool 20 is in the extreme bottom position thereof, the spool closes the hot water passage P1 and thus completely closes, except for leaks, the hot water inlet inside the chamber 11, while opening as much as possible the cold water inlet in the chamber via the open cold water passage P2. Conversely, when the spool 20 is in the extreme top position thereof, the spool closes the cold water passage P2 and thus completely closes, except for leaks, the cold water inlet inside the chamber 11, while opening as much as possible the hot water inlet in the chamber via the hot water passage P1. Of course, depending on the position of the spool 20 along the central axis X-X between the extreme top and bottom positions, the respective closures of the hot water passage P1 and the cold water passage P2 vary inversely, which amounts to saying that the quantities of hot water and cold water admitted inside the chamber 11 are regulated, in respective inverse proportions, by the spool 20 depending on the axial position thereof. In FIGS. 1 to 3, the spool 20 occupies an intermediate position between the extreme top and bottom positions.

According to an advantageous arrangement, which is implemented in the example of embodiment considered herein, the hot water passage P1 and the cold water passage P2 each run about the axis X-X, where appropriate over 360°. For this purpose, the seats 10A, 10B, 20A and 20B each run all about the axis X-X. In this way, the hot water and the cold water distribution is improved in the hot water P1 and cold water P2 passages about the central axis X-X.

The spool 20 is mounted inside the chamber 11 by making the hot water inlet 14 and the cold water inlet 15, leak-tight from each other outside the spool. To this end, in the embodiment considered herein, the spool 20 is provided with a peripheral seal 21 which runs all around the outer lateral face of the spool and which is pressed radially against the lateral wall 17 of the chamber 11 at the central axis X-X, so as to produce leak-tightness with respect to hot water and cold water between the hot water 14 and the cold water 15 inlets. Moreover, for the cold water admitted into the chamber 11 via the cold water inlet 15 to be able to join and mix with the hot water admitted into the chamber via the hot water inlet 14, so as to form the mixed water flowing downstream of the spool 20 as far as the mixed water outlet 16, the spool 20 has flow ports 22, which are visible in FIG. 5 and which connect the opposite axial faces of the spool to each other. It should be noted that the fittings of the spool 20, such as the seal 21, making the hot water 14 and cold water 15 inlets leak-tight to each other outside the spool, and the fittings of the spool, such as the outlet ports 22, letting the flow of cold water past the spool so as to join the hot water, are not limiting.

To drive the spool 20 in translation along the central axis X-X, the cartridge 1 includes a thermostatic element 30 that includes a thermosensitive body 31 and a piston 32 which, in the assembled state of the components of the cartridge, are substantially centered on the central axis X-X. The thermostatic element 30 is designed so that the thermosensitive body 31 thereof and the piston 32 thereof, move with respect to each other along the central axis X-X, such relative movement being controlled by a temperature variation applied to the thermosensitive body 31. To this end, the thermosensitive body 31 contains e.g. a thermally expandable material which, during the expansion thereof, triggers the deployment of piston 32 with respect to the thermosensitive body 31 and which, during the contraction thereof, allows the piston to be retracted with respect to the thermosensitive body. Other forms of thermal actuation are conceivable for the thermostatic element 30. In all cases, so that the relative axial movement between the thermosensitive body 31 and the piston 32 is controlled by the temperature of the mixed water contained in the chamber 11, the thermosensitive body 31 is fitted so as to be in contact with the mixed water, being at least partially arranged in the chamber 11 and/or in the mixed water outlet 16.

The thermosensitive body 31 is rigidly connected to the spool 20, e.g. by screwing, it being underlined that the embodiment of the rigid attachment between the spool 20 and the thermosensitive body 31 is not limiting and, above all, that the rigid attachment extends as a kinematic connection from one to the other for the purpose of moving the spool for closing, in respective inverse proportions, the passages of hot water P1 and cold water P2. The piston 32 is connected to the casing 10 by a mechanism, referenced 40 and detailed below.

Assuming that the mechanism 40 holds the position of the piston 32 fixed along the central axis X-X with respect to the casing 10, the temperature of the mixed water at the outlet of the cartridge 1 is regulated thermostatically by the spool 20 and the thermostatic element 30. Indeed, under such an assumption, the temperature of the mixed water results directly from the respective quantities of hot water and of cold water admitted into the chamber 11 via the hot water passage P1 and the cold water passage P2 respectively, which are closed off by the spool 20 to a greater or lesser extent, as explained above. If the supply of hot and/or cold water to the cartridge is disturbed and, e.g., the temperature of the mixed water increases, the piston 32 extends axially with respect to the thermosensitive body 31, which makes the thermosensitive body 31 and thus the spool 20 to move downwards: the proportion of hot water circulating through the hot water passage P1 decreases while, conversely, the proportion of cold water circulating through the cold water passage P2 increases, resulting in a decrease in the temperature of the mixed water. A reverse reaction occurs when the temperature of the mixed water decreases, and it should be noted that a compression spring 33 is provided for returning the thermostatic body 31 and the piston 32 toward each other when the piston retracts, e.g. during a contraction of the thermally expandable material contained in the thermosensitive body 31. In the example of embodiment considered in the figures, the return spring 33 is interposed axially between the casing 10 and the spool 20. The temperature corrections of the mixed water result in a regulated equilibrium of the temperature of the mixed water, at a thermostatically regulated temperature that depends on the position, as imposed by the mechanism 40, of the piston 32 along the central axis X-X.

The mechanism 40 can be used for adjusting the value of the thermostatically regulated temperature and thus for controlling the temperature of the mixed water, by acting on the axial position of the piston 32. In the example of embodiment considered herein, the mechanism 40 is borne by the upper housing 13 and includes a stop 41 against which the upper end of the piston 32 bears axially and which is mounted so as to slide along the central axis X-X inside a nut 42, with axial interposition between the stop 41 and the nut 42 of an overtravel spring 43. The axial position of the nut 42 inside the casing 10 and, consequently, the height of the stop 41, can be modified by an adjusting screw 44, which is centered on the central axis X-X, the upper end of which emerging from the upper housing 13 so as to be connected in rotation with a maneuvering handle, not shown in the figures. At the lower end thereof, the adjusting screw 44 is screwed into the nut 42, the latter being connected in rotation about the central axis X-X to the upper housing 13, typically by means of splines. Thus, when the screw 44 is rotated on itself about the central axis X-X, the nut 42 is translated along the central axis, which triggers the corresponding driving of the stop 41 by means of the overtravel spring 43, being emphasized that the overtravel spring 43 is substantially stiffer than the return spring 33.

The structure and the operation of the adjustment mechanism 40 will not be described further herein since it is understood that the reader can refer to FR 2 869 087 for such purpose. It will be recalled that the embodiment of the mechanism 40 does not limit the invention: other embodiments are known in the [prior] art, e.g. from FR 2 921 709, FR 2 774 740 and FR 2 870 611. Moreover, as a variant (not shown), if the value of the temperature at which the spool 20 regulates the mixture of hot water and cold water is not regulated, the mechanism 40 can be eliminated from the thermostatic cartridge 1, the piston 32 then being rigidly connected to the casing 10.

We will now return to a more detailed description of the spool 20, referring more specifically to FIGS. 2, 3 and 5.

As can be seen clearly in FIG. 5, the spool 20 has a profile, i.e. an external contour, which is non-circular in a section transverse to the central axis X-X, in other words in a projection in a plane perpendicular to said axis.

More precisely, in the example of embodiment considered in the figures, the profile of the spool 20 is elliptical, being centered on the central axis X-X and defining, a major axis which extends perpendicularly to the central axis X-X and which will be referred to hereinafter as the “first geometric axis”, being referenced by Z1, and a minor axis, which extends perpendicularly both to the central axis X-X and to the first geometric axis Z1 and which will be referred to hereinafter as the “second geometric axis”, being referenced by Z2. Thus, the profile of the spool 20 is more extended along the first geometric axis Z1 than along the second geometric axis Z2. In other words, as noted in FIG. 5, the profile of the spool 20 has a dimension d1 measured along the first geometric axis Z1 and a dimension d2 measured along the second geometric axis Z2, the dimension d1 being greater than the dimension d2.

Of course, the chamber 11 is suitable for the non-circular profile of the spool 20 in the sense that, in a section transverse to the central axis X-X, the chamber 11 has, at the axial level of the spool 20, a non-circular section that matches the profile of the spool. Thus, as can be seen clearly in FIGS. 1 to 3, the chamber 11, more precisely the lateral wall 17 of the latter, is cylindrical with an elliptical base, which is centered on the central axis X-X, the major axis of which extends along the first geometric axis Z1 and the minor axis of which extends along the geometric axis Z2. The same applies to the seal 21.

It should be noted that the elliptical shape illustrated in the figures is only an example of a non-circular geometry for the profile of the spool 20 and, consequently, for the matching section of the chamber 11. Thus, more generally, the profile of the spool 20 is different from a circle, in the sense that the profile of the spool 20 differs from the profile of known spools, which is typically substantially circular, i.e. circular within manufacturing tolerances.

The non-circularity of the profile of the spool 20 allows the thermostatic cartridge 1 to adapt to various geometries of the surroundings. Thus, it will be understood that when e.g. the surroundings of the thermostatic cartridge 1 limits the possibility for the latter to occupy a given portion of the space about the central axis X-X, the profile of the spool 20 is then advantageously designed truncated in said portion. Consequently, the precise geometry of the profile of the spool 20 is not limiting for the invention as long as the geometry is non-circular as indicated above. Thus, the profile of the spool 20 can advantageously be either asymmetrical or symmetrical. Examples of asymmetric profiles include a truncated circular profile, a multilobed profile, etc. Examples of symmetrical profiles include an oval profile, a profile including one or a plurality of pairs with parallel opposite rectilinear edges, such as a rectangular or square profile with rounded corners, etc. In all cases, it should be noted that, compared to a circular profile of known spools, the non-circular profile of the spool 20 does not limit the flow rate of the mixed water coming from the thermostatic cartridge 1, in the sense that, compared to a spool with a given circular profile and hence a corresponding perimeter, the non-circular profile of the spool 20 is advantageously dimensioned so as to have the same perimeter value and thus the same flow cross-section values for the hot water P1 and the cold water P2 passages.

According to a preferred arrangement, the profile of the spool 20 has a geometric shape that is more extended along the first geometric axis Z1 than along the second geometric axis Z2. Such arrangement is implemented in the example of embodiment considered in the figures, as detailed above in relation to the dimensions d1 and d2 of the elliptical shape. In variants (not shown), such arrangement is implemented with other geometries for the profile of the spool 20, in particular an oval geometry or a geometry including two parallel rectilinear edges, such as an oblong geometry or a rectangular geometry with rounded corners. In all cases, such arrangement advantageously allows the thermostatic cartridge 1 to be apt to be implanted in an environment with reduced width, i.e. an environment with a dimension smaller than the other two dimensions thereof. Indeed, as in the example of embodiment considered in the figures, the casing 10 can then be provided “flattened” along the second geometric axis Z2, in the sense that the casing 10 then has a total dimension, measured along the second geometric axis Z2 and named D in FIGS. 3 and 4, which is smaller than all the other total dimensions of the casing. Moreover, in order to leave free the flanks of the casing 10 through which the second geometric axis Z2 passes, it is then advantageously provided that the hot water inlet 14, the cold water inlet 15 and the mixed water outlet 16 extend from the chamber 11 in the same geometric plane containing the central axis X-X and the first geometric axis Z1, the geometric plane being named π in FIG. 1 and corresponding to the sectional plane of FIG. 2.

In all cases, it should be noted that the non-circular geometry of the profile of the spool 20 can, as in the embodiment considered in the figures, induce a non-circular geometry for the casing 10, in particular at the connection interface between the lower housing 12 and the upper housing 13 of the casing. The fixed connection between the housings 12 and 13 is then impossible by means of screwing, but is advantageously achieved by an added part. In the example of embodiment considered in the figures, the added part is referenced 50 and consists of a fork that is fitted transversely to the central axis X-X. The embodiment of the added part 50 is not limiting.

Finally, various arrangements and variants of the thermostatic cartridge 1 described up to now are further conceivable. Examples include:
rather than the hot water inlet 14 and the cold water inlet 15 extending from the chamber 11 radially to the central axis X-X and emerging, opposite the chamber, laterally to the casing 10, the hot water and cold water inlets can be provided as in FIGS. 6 and 7 which illustrate a variant wherein the casing, the hot water inlet and the cold water inlet of the thermostatic cartridge are referenced 10′, 14′ and 15′, respectively. The hot water inlets 14′ and cold water inlets 15′ extend from the chamber 11 parallel to the axis X-X and emerge, opposite the chamber, on the side of the casing 10′ opposite the side of the mechanism 40. The variant of FIGS. 6 and 7 illustrates the fact that the arrangement of the hot water and the cold water inlets within the casing of the thermostatic cartridge is not limiting for the invention, while noting that the casing 10′ herein has the same advantages as the advantages described above for the casing 10 related to the total dimension D and the geometric plane π; and/or
rather than the casing 10 or 10′, the spool 20 and the thermostatic element 30, and, where appropriate, the mechanism 40, are assembled together in the form of a thermostatic cartridge suitable for being added in a single piece in a tap body, such as the thermostatic cartridge 1 envisaged hitherto, the spool 20 and the thermostatic element 30, and in addition to, where appropriate, the mechanism 40, able to be installed directly in a tap body, the latter then forming a casing functionally similar to the casing 10 or 10′.

1-10. (canceled)

11. A thermostatic assembly, comprising:
a casing in which are delimited:
a chamber which defines a central axis and in which a hot fluid and a cold fluid mix for forming a mixed fluid,
a hot fluid inlet through which the hot fluid enters the chamber from outside the casing,
a cold fluid inlet through which the cold fluid enters the chamber from outside the casing, and
a mixed fluid outlet through which the mixed fluid contained in the chamber exits the casing;
a thermostatic element which includes a thermosensitive body, arranged for being in contact with the mixed fluid, and a piston connected to the casing, the thermosensitive body and the piston moving relative to each other along the central axis depending on the temperature of the mixed fluid; and
a spool for regulating the temperature of the mixed fluid, the spool being connected to the thermosensitive body of the thermostatic element so as to be moved along the central axis inside the chamber so as to close off, in opposite respective proportions, a hot fluid passage and a cold fluid passage which are each delimited, along the central axis, between the spool and the casing, the hot fluid passage being fed by the hot fluid coming from the hot fluid inlet while the cold fluid passage is fed with the cold fluid coming from the cold fluid inlet,
wherein the spool has, in a section transverse to the central axis, a profile which is non-circular.

12. The thermostatic assembly according to claim 11, wherein the profile of the spool has a first dimension, as measured along a first geometric axis perpendicular to the central axis, which is greater than a second dimension of the profile of the spool, as measured along a second geometric axis perpendicular to both the central axis and the first geometric axis.

13. The thermostatic assembly according to claim 12, wherein the profile of the spool is oval.

14. The thermostatic assembly according to claim 13, wherein the profile of the spool is elliptical.

15. The thermostatic assembly according to claim 12, wherein the profile of the spool includes two parallel rectilinear edges, the profile being in particular oblong or rectangular with rounded corners.

16. The thermostatic assembly according to claim 15, wherein the profile of the spool is oblong or rectangular with rounded corners

17. The thermostatic assembly according to claim 12, wherein the casing has a total dimension measured along the second geometric axis, which is smaller than all the other total dimensions of the casing.

18. The thermostatic assembly according to claim 12, wherein the hot fluid inlet, the cold fluid inlet and the mixed fluid outlet extend from the chamber in the same geometric plane containing the central axis and the first geometric axis.

19. The thermostatic assembly according to claim 12, wherein the casing includes a first housing and a second housing, which are distinct from each other, the hot fluid passage being delimited between the spool and the first housing while the cold fluid passage is delimited between the spool and the second housing, and wherein the first housing and the second housing are rigidly joined to each other by means of an added part.

20. The thermostatic assembly according to claim 19, wherein the added part is a fork which is arranged transversely to the central axis.

21. The thermostatic assembly according to claim 19, wherein the thermostatic assembly further includes a mechanism for controlling the temperature of the mixed fluid, the mechanism being borne by the second housing and connecting the piston of the thermostatic element to the casing so as to adjust the position of the piston along the central axis.

22. The thermostatic assembly according to claim 11, wherein the thermostatic assembly forms a thermostatic cartridge adapted for being added in a single piece into a tap body.
